(19) United States
(12) Patent Application Publication
(10) Pub. No.: US 2016/0279740 A1
(43) Pub. Date: Sep. 29, 2016

(54) METHOD AND FILLER MATERIAL STRUCTURE OF HIGH TEMPERATURE BRAZE REPAIR FOR DAMAGES OF BASE ALLOY COMPONENTS

(71) Applicant: Siemens Energy, Inc., Orlando, FL (US)

(72) Inventors: Hang Li, Clover, SC (US); Somesh J. Ghunakikar, Orlando, FL (US); William J. Lowe, Pfafftown, NC (US); Mark A. Garcia, Pfafftown, NC (US)

(21) Appl. No.: 14/669,420

(22) Filed: Mar. 26, 2015

(51) Int. Cl. B23K 35/02; B23K 1/00; B32B 15/01; B23K 35/30

(52) U.S. Cl. CPC B23K 35/0238; B23K 35/3033; B23K 35/3046; B23K 1/00; B32B 15/01

(57) ABSTRACT

A method of braze repair of a base alloy component that includes a braze thermal cycle including a specially chosen peak braze temperature holding time segment and a purposely selected subsequent diffusion heat treatment segment. A multi-layer braze filler material structure used for the braze repair of a base alloy component including at least a first superalloy layer and a single mixture layer. The single mixture layer including at least a braze alloy and a second superalloy.

### BACKGROUND

1. Field

The present invention relates to a method of repairing damages of a base alloy component by a brazing process comprising filler material selection, filler material structure arrangement and thermal cycle design used during the repair, particularly for heavy damage braze repairs.

2. Description of the Related Art

Cast grade superalloys are widely used for critical gas turbine engine hot section components due to their superior high temperature strength and oxidation/hot corrosion resistances. Due to challenging working environments encountered during engine operation, these superalloy components can be severely degraded through significant high temperature thermal mechanical fatigue (TMF) cracking and heavy hot gas erosion damage. These cast grade superalloy components are expensive. To lower engine user's operation costs, common industrial practices are to conduct overhaul operations to extend the service life of these parts.

Brazing technologies are frequently used for cast grade superalloy component TMF cracking and erosion damage repair works. For light TMF cracking and erosion damages, transient liquid phase bonding (TLP) and modified braze/alloy single mixture TLP technologies are commonly applied. For large TMF cracking and heavy erosion/TMF damage braze repairs, large volumetric braze fillers are used at braze repair sites to heal the damages and TLP or modified TLP can no longer apply due to technical issues caused by shrinkage and isothermal solidification related braze joint centerline brittle intermetallic phase formation. Currently, brazing methods involving multiple layers of braze and superalloy powder filler material applications are used. These superalloy powders can be applied in powder, putty, slurry and flexible tape forms. High peak temperature brazing and subsequent diffusion heat treatment are two typical segments of a full brazing heat treatment thermal cycle; the first one aimed to melt the braze alloy to form braze repair sites and the later one designed to homogenize repair sites with base alloy through diffusion of melting point depressing elements.

Different from light damage braze repair, heavy damage repairs require greater amounts of filler material with much larger quantities of braze alloys. Typically there are lengthy peak braze temperature and diffusion temperature holding times. These braze alloys contain certain amounts of melting depressing/active diffusing types of elements such as Boron, Silicon, Phosphorous and the like. These elements are vitally important parts of the braze alloys, however, these elements presented as parts of lower melting point liquid brazes, once entered in these braze repair sites and in contact with the base alloy, can also create very negative impacts at the braze repair sites.

Negative impacts from the melting depressing/active diffusing types of elements can include: eroding of the base alloy resulting in localized partial melting of base alloy and formation of cavities at the braze repair sites, especially Boron containing braze alloys for Cobalt base superalloys; formation of hard and brittle intermetallic phases inside the braze repair sites and in their surrounding base alloys degrading the braze repair site mechanical properties; restricting allowable multiple repair cycles; and reducing re-melt temperatures of the braze repair sites. The re-melt temperature is a vital value for any successful braze repair in component repair applications as these components must perform well in high temperature environments and usually have high temperature protective coatings applied on the surfaces. When large amounts of the braze alloy is applied at the braze repair site, once melted and under the effect of gravity, the braze alloy can spread the negative impacts of these harmful elements to locations far away from the braze repair site.

### SUMMARY

In one aspect of the present invention, a multi-layer braze filler material structure for the braze repair of a base alloy component comprising at least a first superalloy layer and a single mixture layer, wherein the single mixture layer comprises a braze alloy and a second superalloy.

In another aspect of the present invention, a method of braze repair of a base alloy component comprising the steps of: placing a multi-layer braze filler material structure on a braze repair site on the base alloy component, wherein the multi-layer braze filler material structure comprises at least a first superalloy layer and a single mixture layer, wherein the single mixture layer comprises a braze alloy and a second superalloy; placing the base alloy component and multi-layer braze filler material structure in a braze thermal cycle, wherein the braze thermal cycle comprises a peak braze temperature holding time segment, wherein a brazing peak temperature of the peak braze temperature holding time segment is held for a peak braze temperature holding time, and a subsequent diffusion heat treatment segment, wherein the base alloy component and multi-layer braze filler material structure is held at a homogenization diffusion temperature; and selecting the brazing peak temperature approximately within an upper half of a brazing temperature range of the braze alloy.

### BRIEF DESCRIPTION OF THE DRAWINGS

The invention is shown in more detail by help of figures. The figures show preferred configurations and do not limit the scope of the invention.

FIG. 1 is a cross section of a braze process arrangement of an exemplary embodiment of the present invention;

FIG. 2 is a cross section of a braze process arrangement of an alternate embodiment of the present invention; and

FIG. 3 is a top view of a test block I;

FIG. 4 is a side cross sectional view of the test block I in FIG. 3;

FIG. 5 is a top view of a test block II; and

FIG. 6 is a side cross sectional view of the test block II in FIG. 5.

### DETAILED DESCRIPTION

Broadly, an embodiment of the present invention provides a method of braze repair of a base alloy component and multi-layer braze filler material structure for the braze repair of a base alloy component including at least a first superalloy layer and a single mixture layer, wherein the single mixture layer includes at least a braze alloy and a second superalloy.

When a base alloy component, such as a cast grade superalloy component, has damages, such as erosion damage, TMF cracking, or the like, the area that includes these damages may be called the repair site. The base alloy component may be a superalloy that may be cast grade, another type of alloy, or the like. When a brazing process is used to repair the damages, the area needing repair may be called the braze repair site. In the brazing process, filler materials are used to fill in the cracks and eroded areas along and within the braze repair site.

When braze repairing high temperature components such as critical gas turbine engine hot section components using multi-layer filler construction, cast grade superalloy components and the like, major micro scale and macro scale mass transfers occur. Macro scale mass transfers include surface energy driven liquid braze infiltrating and filler alloy powder consolidation, as well as gravity driven liquid braze overflow. Micro scale mass transfers include excessive harmful melting point depressing element rich liquid phase induced base alloy erosion, intrusion and diffusion resulting in formation of harmful element rich brittle intermetallic phases deep inside the base alloy. The final outcomes of a brazing repair process rely on the ways these macro and micro scale mass transfer processes evolve during a brazing thermal cycle and a set of brazing thermal cycle segments.

A more precise control over each of the major mass transfer processes is desirable. Embodiments of the present invention provide a method of repair and braze filler material structure that may allow for the reduction of melting point depression elements, restriction of gravity driven braze external overflow, limitation of brittle intermetallic phase formation in base alloy and the elimination of brazing related base alloy erosion without compromising the braze repair site re-melt temperature requirement.

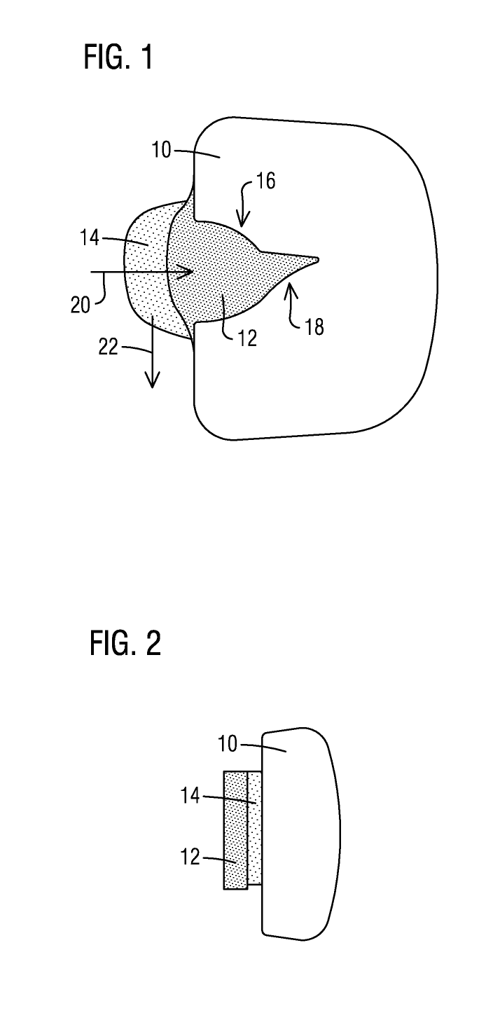

As is illustrated in FIGS. 1 and 2, a base alloy 10 may be damaged by erosion 16, TMF cracks 18, or the like. A damaged base alloy 10 such as a cast grade superalloy component, or the like, may be in need of repair through a brazing process. A multi-layer braze filler material structure may be used to fill in the damage along a braze repair site 32. The multi-layer braze filler material structure may include at least a first superalloy layer and a single mixture layer. The first superalloy layer may include a first superalloy 12 and the single mixture layer may include a separate single mixture 14. The first superalloy 12 may be from a material such as a Nickel (Ni) based cast grade alloy, a Cobalt (Co) based cast grade alloy, or the like. The first superalloy 12 may be in the form of a putty, a powder layer, a flexible tape, a slurry or the combination of different forms.

The single mixture 14 may include a braze alloy and a second superalloy. The braze alloy may be made from a Ni based braze alloy, a Co based braze alloy, or the like, that includes at least one melting point depressing element such as Boron (B), Silicon (Si), Phosphorous (P) or the like. The second superalloy may be from a material such as a Ni based cast grade alloy, a Co based cast grade alloy, or the like, that may be compatible with the braze alloy and the base alloy 10. In certain embodiments, the first superalloy 12 and the second superalloy may be made of the same material.

In certain embodiments, the braze alloy may be a non-eutectic type of braze alloy. The non-eutectic type of braze alloy may allow for improved control over the overflow of the braze alloy. The non-eutectic type of braze alloy may allow the braze alloy to be slow moving as a mixture of liquid and solid material, allowing for less time to produce overflow of the braze alloy outside of the braze repair site 32 during the brazing process. The mixture of the braze alloy and the second superalloy may also allow for additional control over the gravity driven free flow downward during the braze repair process.

In certain embodiments, a mixture ratio of the braze alloy to the second superalloy may be within a range of approximately 95 percent braze alloy/5 percent second superalloy to approximately 60 percent braze alloy/40 percent second superalloy. The single mixture reduces the total amount of melting point depressing elements within the multi-layer braze filler material structure and may help reduce the spread of the melting point depressing elements away from the braze repair site 32.

In certain embodiments, the multi-layer braze filler material structure may first have the first superalloy 12 placed within the braze repair site 32 of the base alloy 10. The first superalloy 12 can be in powder form, putty, slurry, tape or combination of these forms. The single mixture 14 may then be placed over and around the first superalloy 12 as is shown in FIG. 1.

In certain embodiments, the multi-layer braze filler material structure may be in a double layer tape structure. The single mixture 14 may bond together with the first superalloy 12. The single mixture 14 and the first superalloy 12 may bond together in certain predetermined proportions. In this embodiment, the single mixture 14 may be sandwiched between the base alloy 10 and the first superalloy 12 as is shown in FIG. 2. The single mixture 14 may be placed along the braze repair site 32 of the base alloy 10. The first superalloy 12 may then be placed over the single mixture 14 in a tape structure.

A method of braze repair of the base alloy 10 such as the cast grade superalloy component may include placing the multi-layer braze filler material structure on the braze repair site 32 on the base alloy 10. The base alloy 10 with multi-layer braze filler material structure may be sent through a braze thermal cycle. The braze thermal cycle may include a peak braze temperature holding time segment. The peak braze temperature holding time segment may hold the base alloy 10 and multi-layer braze filler material structure at a brazing peak temperature for the extent of a braze peak temperature holding time. During the peak braze temperature holding time, the single mixture 14 may at least partially liquefy and infiltrate and consolidate with the first superalloy 12.

The braze peak temperature holding time may be within a range of approximately two minutes to approximately thirty minutes at the brazing peak temperature. The brazing peak temperature may be selected to be approximately within an upper half of a brazing temperature range of the braze alloy. In certain embodiments, the brazing peak temperature may be selected to be approximately a high temperature limit of the brazing temperature range of the braze alloy. This high temperature limit may be determined by the original equipment manufacturer (OEM), vendor, or the like, of the braze alloy.

The braze thermal cycle may also include a subsequent diffusion heat treatment segment where a homogenization diffusion temperature may be set. The diffusion heat treatment segment may be for a reduced amount of time to reduce the amount of melting point depressing elements entering into the base alloy 10. The homogenization diffusion temperature may be set to be approximately within a melting range of the braze alloy. The homogenization diffusion temperature may be set to be approximately within a lower half of the melting range of the braze alloy. Due to the relative high homogenization diffusion temperature, the diffusion heat treatment segment may be held for a decreased amount of time versus a current diffusion heat treatment segment time.

In certain embodiments, the brazing temperature range of the braze alloy may be approximately 1800 degrees Fahrenheit to approximately 2350 degrees Fahrenheit. In certain embodiments, the melting range of the braze alloy may be approximately 1700 degrees Fahrenheit to approximately 2250 degrees Fahrenheit.

In certain embodiments, surface energy driven liquid braze may infiltrate and consolidate with the first superalloy in a direction 20 that is shown in FIG. 1. A gravity driven liquid braze alloy external flow direction 22 may be approximately perpendicular to the direction of the surface energy driven liquid braze infiltration direction 20. The gravity driven liquid braze alloy external flow direction 22 may be opposite to the direction of the surface energy driven liquid braze infiltration direction 20 if the brazing setup orientation is set in an upside down position.

Testing occurred comparing a wide gap test block I brazed with the current double layer method using a pure braze alloy with a thermal cycle outside the braze thermal cycle described above, and a wide gap test block II brazed with an embodiment of a method of the present invention using a single mixture 14 and a braze thermal cycle described above. Both test blocks were tested with the same filler alloy, that was a first superalloy 12, and tested at the same braze peak temperature.

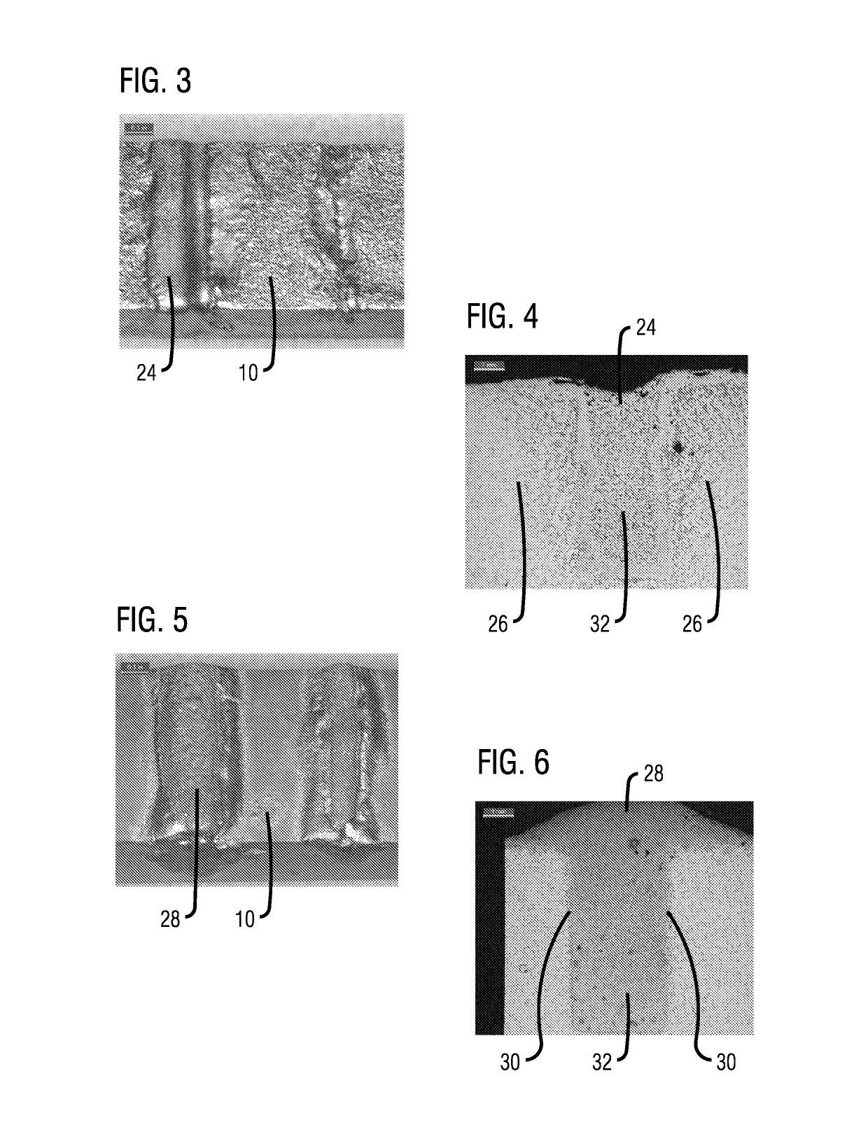

Results from the testing showed that test block I suffered from excessive braze alloy external overflow as is shown in FIGS. 3 and 4. The braze alloy caused heavy erosion on the base alloy 10 as well as wash away some of the filler alloy resulting in concave braze top surfaces 24. Large quantities of boron rich intermetallic phases 26 entered the base alloy in the vicinities of the braze repair site 32. These issues are all associated with negative impacts of melting point depression elements on multi-layer wide gap brazing.

Results showed that test block II showed no sight of base metal erosion and very little boron rich intermetallic phases 30 in the base metal as is shown in FIGS. 5 and 6. The excessive braze alloy external overflow issue was well contained and a convex shaped braze cap 28 appeared at the top of each slot brazed. All negative impacts of boron to the base metal and the entire braze repair site 32 were significantly reduced with an embodiment of the present invention. The re-melt temperature at the braze repair site 32 were also found to be much higher than the maximum allowable service temperature of the base alloy 10.

The single mixture 14 with the first superalloy 12 structure allows for a sound braze repair site 32 without base alloy erosion and limited melting point depressing element rich intermetallic phases in the base alloy 10. This reduction in base alloy erosion and limitation of melting point depressing element rich intermetallic phases in the base alloy may occur in wide gap slots, midsized gap slots and small gap slots. The re-melt temperatures of the braze repair sites 32 through embodiments of the present invention may be higher than the maximum allowable service temperatures of the base alloy 10.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

What is claimed is:

1. A multi-layer braze filler material structure for the braze repair of a base alloy component comprising at least a first superalloy layer and a single mixture layer, wherein the single mixture layer comprises a braze alloy and a second superalloy.

2. The multi-layer braze filler material structure of claim 1, wherein the braze alloy material is a Nickel base braze alloy comprising at least one melting point depressing element.

3. The multi-layer braze filler material structure of claim 1, wherein the braze alloy material is a Cobalt base braze alloy comprising at least one melting point depressing element.

4. The multi-layer braze filler material structure of claim 1, wherein the braze alloy is non-eutectic.

5. The multi-layer braze filler material structure of claim 1, wherein the second superalloy material is a Nickel base superalloy compatible with both the braze alloy and the cast grade superalloy component.

6. The multi-layer braze filler material structure of claim 1, wherein the second superalloy material is a Cobalt base superalloy compatible with both the braze alloy and the cast grade superalloy component.

7. The multi-layer braze filler material structure of claim 1, wherein the mixture has a braze alloy to second superalloy mixing ratio range of approximately 95 braze alloy/5 second superalloy to approximately 60 braze alloy/40 second superalloy.

8. The multi-layer braze filler material structure of claim 1, wherein the multi-layer braze filler material structure comprises a double layer tape, wherein the single mixture layer is in direct contact with the base alloy component, and the first superalloy layer is on the exterior of the single mixture layer.

9. A method of braze repair of a base alloy component comprising the steps of:
placing a multi-layer braze filler material structure on a braze repair site on the base alloy component, wherein the multi-layer braze filler material structure comprises at least a first superalloy layer and a single mixture layer, wherein the single mixture layer comprises a braze alloy and a second superalloy;
placing the base alloy component and multi-layer braze filler material structure in a braze thermal cycle, wherein the braze thermal cycle comprises a peak braze temperature holding time segment, wherein a brazing peak temperature of the peak braze temperature holding time segment is held for a peak braze temperature holding time, and a subsequent diffusion heat treatment segment, wherein the base alloy component and multi-layer braze filler material structure is held at a braze homogenization diffusion temperature; and
selecting the brazing peak temperature approximately within an upper half of a brazing temperature range of the braze alloy.

10. The method of claim 9, wherein the brazing peak temperature selected is approximately a high temperature limit of a brazing temperature range of the braze alloy.

11. The method of claim 9, wherein the braze peak temperature holding time is in a range of approximately two minutes to approximately thirty minutes at the brazing peak temperature.

12. The method of claim 9, wherein the braze homogenization diffusion temperature is within a melting range of the braze alloy.

13. The method of claim 12, wherein the braze homogenization diffusion temperature is approximately within a lower half of the melting range of the braze alloy.

14. The method of claim 9, wherein the braze alloy is non-eutectic.

15. The method of claim 9, wherein the single mixture has a braze alloy to second superalloy mixing ratio range of approximately 95 braze alloy/5 second superalloy to approximately 60 braze alloy/40 second superalloy.

16. The method of claim 9, wherein the multi-layer braze filler material structure comprises a double layer tape, wherein the single mixture layer is in direct contact with the base alloy component, and the first superalloy layer is on the exterior of the single mixture layer.
